(19) United States
(12) Patent Application Publication
(10) Pub. No.: US 2025/0300210 A1
(43) Pub. Date: Sep. 25, 2025

(54) ELECTRODE TRANSFER APPARATUS AND ELECTRODE TRANSFER METHOD

(71) Applicant: SK ON CO., LTD., Seoul (KR)

(72) Inventors: Ju Hyeon LEE, Daejeon (KR); Chang Won LEE, Daejeon (KR)

(21) Appl. No.: 19/088,996

(22) Filed: Mar. 25, 2025

(30) Foreign Application Priority Data
Mar. 25, 2024 (KR) 10-2024-0040488
Mar. 13, 2025 (KR) 10-2025-0032782

(51) Int. Cl. H01M 10/04

(52) U.S. Cl. CPC H01M 10/0404; H01M 10/0459

(57) ABSTRACT

The electrode transfer apparatus according to an exemplary embodiment of the present disclosure may include: an electrode magazine configured to load electrodes; an alignment table positioned with a gap from the electrode magazine; a first transfer unit configured to reciprocate between the electrode magazine and the alignment table, and adsorb and transfer the electrode; a multi-sheet detection unit configured to detect whether an electrode placed on the alignment table is a multi-sheet electrode; a lower adsorption unit mounted on the alignment table and configured to adsorb the electrode from below; and a controller configured to control activation/deactivation (on/off) of the adsorption force of the first transfer unit based on detection results from the multi-sheet detection unit.

### CROSS-REFERENCE TO RELATED APPLICATION

This patent application claims the priority and benefits of Korean patent application No. 10-2024-0040488, filed on Mar. 25, 2024 and No. 10-2025-0032782, filed on Mar. 13, 2025 the disclosure of which is incorporated herein by reference in its entirety.

### BACKGROUND

### 1. Field of the Invention

The present disclosure relates to an electrode transfer apparatus and an electrode transfer method using the same.

### 2. Description of the Related Art

Various types of secondary batteries are used in electric vehicles and electronic apparatus as energy sources for these applications. The secondary batteries typically use a jelly-roll type electrode assembly in which an anode plate, a cathode plate and separators are wound together. Alternately, an electrode assembly fabricated by stacking an anode plate, a cathode plate and a separator in a predetermined order is also used.

### SUMMARY

An embodiment of the present disclosure is to propose an electrode transfer apparatus and method, which are capable of minimizing a waste rate of electrodes and increasing an electrode yield in a secondary battery manufacturing process.

An electrode transfer apparatus according to exemplary embodiment of the present disclosure may include: an electrode magazine configured to load electrodes; an alignment table positioned with a gap from the electrode magazine; a first transfer unit configured to reciprocate between the electrode magazine and the alignment table, and adsorb and transfer the electrode; a multi-sheet detection unit configured to detect whether an electrode placed on the alignment table is a multi-sheet electrode; a lower adsorption unit mounted on the alignment table and configured to adsorb the electrode from below; and a controller configured to control activation/deactivation (on/off) of the adsorption force of the first transfer unit based on detection results from the multi-sheet detection unit.

In an exemplary embodiment, the controller may control the first transfer unit to adsorb the multi-sheet electrode from above and separate at least a portion of the multi-sheet electrode.

In an exemplary embodiment, the controller may control the first transfer unit to transfer the separated portion of the multi-sheet electrode to a first position other than the alignment table.

In an exemplary embodiment, the adsorption force applied by the first transfer unit and the adsorption force applied by the lower adsorption unit may act on the electrode in opposite directions.

In an exemplary embodiment, the adsorption force applied by the first transfer unit may be configured to be greater than or equal to the adsorption force applied by the lower adsorption unit.

In an exemplary embodiment, the multi-sheet detection unit may detect a thickness of the electrode placed on the alignment table to determine whether it is a multi-sheet electrode.

In an exemplary embodiment, the controller may control the lower adsorption unit to be deactivated when the portion of the multi-sheet electrode is separated by the first transfer unit.

In an exemplary embodiment, the electrode transfer apparatus may further include a second transfer unit configured to transfer the residual portion of the multi-sheet electrode remaining on the alignment table to a second position.

In an exemplary embodiment, the first transfer unit may include a plurality of first adsorption units arranged at multiple positions to adsorb the electrode from above, and a plurality of lower adsorption units are arranged at multiple positions, wherein the first adsorption units are arranged at positions corresponding to the lower adsorption units, respectively.

An electrode transfer method according to exemplary embodiment of the present disclosure may include: adsorbing an electrode and transferring it to an alignment table, by a first transfer unit; detecting whether the electrode is a multi-sheet electrode in which an upper electrode and a lower electrode are stacked, by multi-sheet detection unit; and controlling activation/deactivation (on/off) of the first transfer unit to adjust its adsorption force based on detection results from the multi-sheet detection unit, by a controller.

In an exemplary embodiment, the electrode transfer method may further include, when the adsorption force of the first transfer unit is activated, adsorbing the upper electrode and separating it from the lower electrode, by the first transfer unit, wherein the step of adsorbing the upper electrode and separating it from the lower electrode is performed while the lower electrode is adsorbed by the lower adsorption unit and remains on the alignment table.

In an exemplary embodiment, the adsorption force applied to the upper electrode by the first transfer unit and the adsorption force applied to the lower electrode by the lower adsorption unit may act on the electrode in opposite directions.

In an exemplary embodiment, the adsorption force applied to the upper electrode by the first transfer unit may be configured to be greater than or equal to the adsorption force applied to the lower electrode by the lower adsorption unit.

In an exemplary embodiment, the electrode transfer method may further include transferring the upper electrode adsorbed by the first transfer unit to a first position other than the alignment table.

In an exemplary embodiment, the electrode transfer method may further include transferring the lower electrode remaining on the alignment table to a second position by the second transfer unit.

In an exemplary embodiment, the step of transferring the lower electrode to the second position may be performed while the lower adsorption unit is deactivated.

In an exemplary embodiment, the electrode transfer method may further include, when the lower electrode is transferred to the second position, re-transferring the upper electrode to the alignment table, by the first transfer unit.

In an exemplary embodiment, the electrode transfer method may further include detecting whether the re-transferred upper electrode is a multi-sheet electrode.

In an exemplary embodiment, the electrode transfer method may further include, when the multi-sheet electrode is not detected, adjusting the alignment state of the electrode placed on the alignment table.

In an exemplary embodiment, the electrode transfer method may further include transferring the electrode or the upper electrode, which has undergone alignment adjustment, to a stacking table, by the second transfer unit.

The electrode transfer apparatus and method according to various embodiments of the present disclosure may minimize the waste rate of electrodes by picking up the multi-sheet electrode from the electrode magazine.

In addition, in the present disclosure, when picking up the multi-sheet electrode in which three or more electrodes are stacked, the problem of the multi-sheet electrode being mixed into the electrode assembly may be minimized.

The electrode transfer apparatus of the present disclosure may maximize the electrode yield in the secondary battery manufacturing process.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view schematically illustrating an electrode transfer process using an electrode transfer apparatus according to an exemplary embodiment of the present disclosure;

FIG. 2 is a view schematically illustrating a process of separating an upper electrode and a lower electrode of a multi-sheet electrode arranged between a first transfer unit and an alignment table in an exemplary embodiment of the present disclosure;

FIG. 3 is a view schematically illustrating an example of how the multi-sheet electrode including the upper electrode and the lower electrode can be placed on the alignment table in an exemplary embodiment of the present disclosure;

FIG. 4 is a block diagram illustrating the connection relationship between components forming the electrode transfer apparatus according to an exemplary embodiment of the present disclosure;

FIG. 5 is a flowchart illustrating the operational sequence of each component of the electrode transfer apparatus according to an exemplary embodiment of the present disclosure; and

FIG. 6 is a flowchart illustrating procedures of an electrode transfer method according to an exemplary embodiment of the present disclosure.

### DETAILED DESCRIPTION OF THE INVENTION

The embodiments of the present disclosure are provided to more fully describe the present disclosure to those skilled art in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe his or her invention, they should be interpreted based on the meanings and concepts that meet the technical ideas of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, theses terms should be construed to imply that the presence of corresponding component, and thus should not be interpreted to exclude the presence of other components but rather to include them.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described to as being “connected” or “coupled” to another component, the component may be directly connected or coupled the another component, but it may be “connected” or “coupled” to the another component intervening another component may be present.

Space-related terms such as “beneath,” “below,” “lower,” “above,” and “upper” may be used to facilitate understanding of the relationship between an element or feature and another element or feature illustrated in the drawings. These space-related terms are provided to facilitate understanding of the present disclosure in their various process or usage states and are not intended impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” or “below” depending on orientation.

The embodiments described in this specification and the configurations illustrated in the drawings merely represent the most preferred embodiments of the present disclosure but do not encompass all technical ideas of the present disclosure. Thus, it should be understood that various modifications and equivalents may be implemented at the time of filing the present application. In addition, the publicly known functions and configurations that are deemed unnecessary for clarifying the essence of the present invention will not be described.

The present disclosure relates to an electrode transfer apparatus for transferring an electrode during an assembly process of an electrode assembly (not shown) that forms a secondary battery.

The electrode transfer apparatus according to various embodiments of the present disclosure may arrange electrodes on a separation membrane (i.e., separator) to form an electrode assembly.

For example, the electrode assembly assembled using the electrode transfer apparatus of the present disclosure may include a first electrode (not shown), a second electrode (not shown) and a separation membrane (not shown). The first electrode and the second electrode may each be provided in a plate shape. The first electrode and the second electrode may each include a current collector and a coating layer including an active material applied to the current collector.

The second electrode may be either a cathode or an anode. If the first electrode is an anode, the second electrode may be a cathode, and if the first electrode is a cathode, the second electrode may be an anode.

In an exemplary embodiment, the first electrode may be a cathode. The first electrode may include a first current collector (not shown) in the form of a metal foil and a first coating layer (not shown) including a cathode active material applied to the first current collector. For example, the first current collector may be a cathode current collector, and may include aluminum.

In an exemplary embodiment, the first coating layer may be an electrically conductive coating that serves as a cathode coating layer. The first coating layer may include a cathode active material. For example, the cathode active material may include lithium nickel manganese cobalt oxide (NMC), lithium manganese oxide (LMO), lithium iron phosphate (LFP), lithium cobalt oxide (LCO), lithium titanate (LTO), or a chalcogenide compound such as lithium titanium sulfide (LiTiS₂), but it is not limited thereto. In addition, any cathode active material known to those skilled in the art may be used.

The first current collector may include a first non-coated part (not shown) where the first coating layer is not formed. For example, the first non-coated part may be a cathode non-coated part, and may serve as a cathode tab.

In an exemplary embodiment, the second electrode may be an anode. The second electrode may include a second current collector (not shown) in the form of a metal foil and a second coating layer (not shown) including an anode active material applied to the second current collector. For example, the second current collector may be an anode current collector, and may include copper or nickel.

In an exemplary embodiment, the second coating layer may be an electrically conductive coating that serves as an anode coating layer. The second coating layer may include an anode active material. For example, the anode active material may include a silicon-based material (e.g., metallic silicon and silicon dioxide), a carbon-based material (e.g., graphite materials, graphene-containing materials, hard carbon, soft carbon, carbon nanotubes, porous carbon, and conductive carbon), a tin-based material, or a metal oxide, but it is not limited thereto. In addition, any anode active material known to those skilled in the art may be used.

The second current collector may include a second non-coated part (not shown) where the second coating layer is not formed. For example, the second non-coated part may be an anode non-coated part and may serve as an anode tab.

The separation membrane may be interposed between the first electrode plate and the second electrode plate to prevent short circuits caused by direct contact between the first electrode plate and second electrode plate. For example, the separation membrane may include an electrically insulating material. For example, the separation membrane may include a polymeric material. For example, the separation membrane may include polyethylene, polypropylene, or a combination thereof, but it is not limited thereto.

The first electrode and the second electrode may be stacked and arranged on the separation membrane. The first electrode and the second electrode may be stacked and arranged alternately based on the separation membrane to form an electrode assembly. For example, in the electrode assembly, the separation membrane may be folded in a Z-folding structure, but it is not limited thereto.

Hereinafter, the electrode transfer apparatus according to various embodiments of the present disclosure will be specifically described with reference to the accompanying drawings.

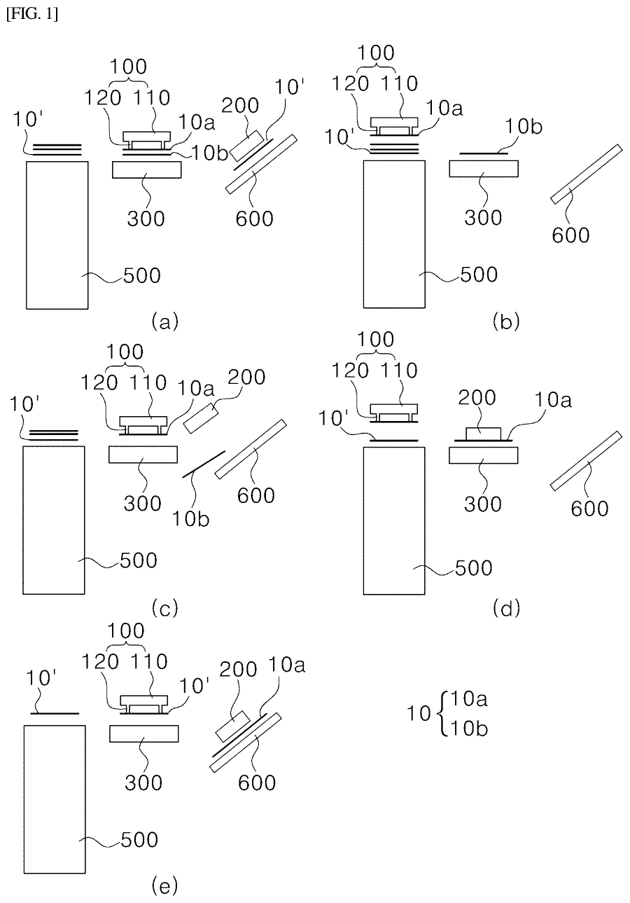

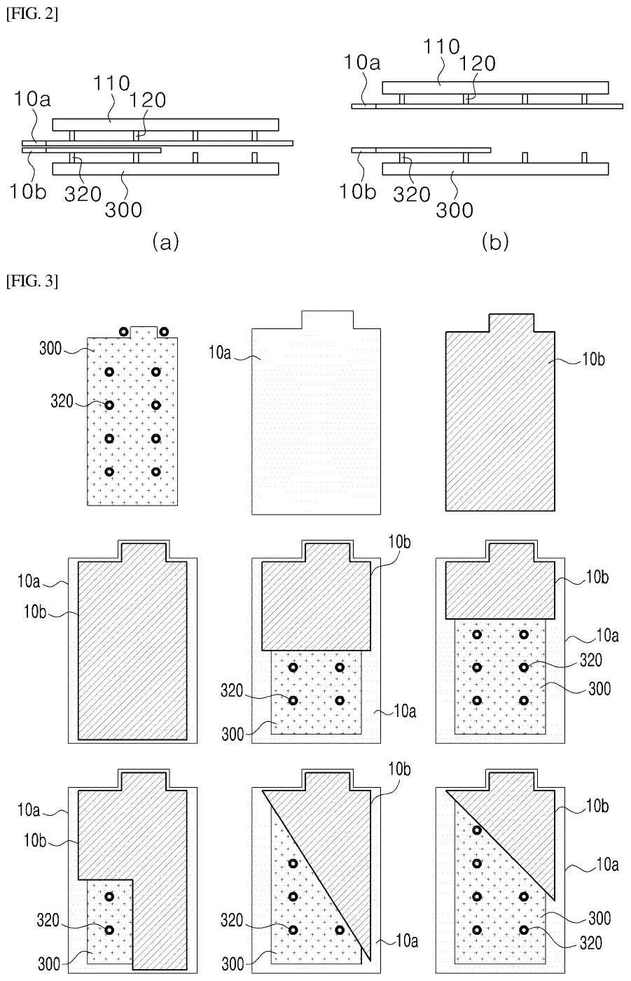

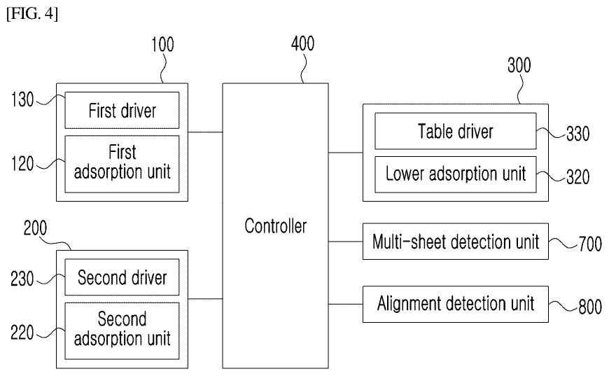

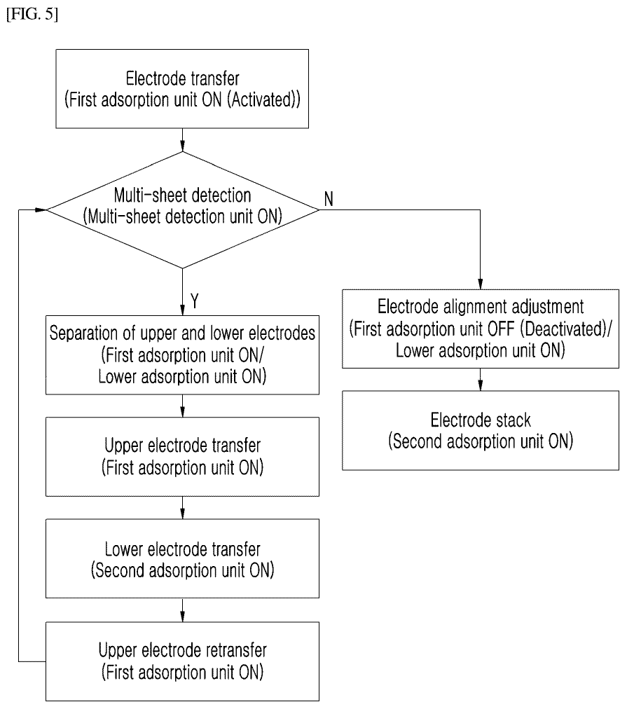

FIG. 1 is a view schematically illustrating an electrode transfer process using the electrode transfer apparatus according to an exemplary embodiment of the present disclosure, FIG. 2 is a view schematically illustrating a process of separating an upper electrode and a lower electrode of a multi-sheet electrode arranged between a first transfer unit and an alignment table in an exemplary embodiment of the present disclosure, FIG. 3 is a view schematically illustrating an example of how the multi-sheet electrode including the upper electrode and the lower electrode can be placed on the alignment table in an exemplary embodiment of the present disclosure, and FIG. 4 is a block diagram illustrating the connection relationship between components forming the electrode transfer apparatus according to an exemplary embodiment of the present disclosure.

Referring to FIGS. 1 to 4, unless otherwise specifically described, an electrode 10′ that can be transferred by the electrode transfer apparatus of the invention, which will be described below, does not specifically refer to either the above-described first electrode or second electrode. For example, it should be understood that the electrode 10′ may also represent the first electrode or the second electrode among the electrodes 10′ forming the electrode assembly.

The electrode 10′ may be prepared by cutting into a plate shape so as to have a preset size. A plurality of electrodes 10′ prepared in advance may be loaded in an electrode magazine 500.

The electrode magazine 500 may be prepared by stacking a plurality of electrodes 10′. The electrode magazine 500 may be prepared while the electrodes 10′ are stacked in a manner that allows them to be picked up and transferred by the first transfer unit 100.

The first transfer unit 100 may hold and transfer the electrodes 10′ stacked in the electrode magazine 500. The first transfer unit 100 may individually transfer each sheet-type electrode 10′ from the electrode magazine 500 one by one.

In the conventional electrode transfer apparatus, when electrodes 10′ are transferred from the electrode magazine 500, there are cases where the stacked electrodes 10′ may fail to separate due to static electricity or adhesion between the electrodes 10′ in the electrode magazine 500, and two or more electrodes 10′ are transferred simultaneously.

Meanwhile, when two or more electrodes 10′ are transferred to the next stage simultaneously, the conventional electrode transfer apparatus discards all of the two or more electrodes 10′ transferred simultaneously. However, regardless of whether the transferred electrodes 10′ are actually defective, all of the two or more transferred electrodes 10′ are discarded, thereby leading to an increase in the unnecessary waste rate and a reduction in the yield of the electrodes 10′ in the manufacturing process.

Therefore, the present disclosure proposes an electrode transfer apparatus and method that can minimize the number of electrodes electrode 10′ discarded when a defect occurs due to the simultaneous transfer of two or more electrodes 10′, thereby increasing the electrode 10′ yield.

As used herein, the multi-sheet or multi-sheet stacking may refer to a state where two or more electrodes 10′ are overlapped or stacked vertically. The multi-sheet may refer to a state where two electrodes 10′ are stacked, but it is not limited thereto, and may also encompass a state where three or more electrodes 10′ are overlapped.

As used herein, the multi-sheet electrode 10 or multi-sheet stacked electrode 10′ may refer to the entire set of electrodes 10′ while two or more are overlapped.

The multi-sheet electrode 10 may be described as including an upper electrode 10a and a lower electrode 10b. For example, the lower electrode 10b may refer to the electrode 10′ positioned at the lowest of the multi-sheet electrodes 10, and the upper electrode 10a may refer to the remaining electrode 10′ of the entire multi-sheet electrode 10 excluding the lower electrode 10b. Accordingly, the upper electrode 10a may also represent one electrode 10′ of the multi-sheet electrodes 10 excluding the lower electrode 10b, or two or more electrodes 10′.

### Electrode Transfer Apparatus

Referring to FIGS. 1 to 4, the electrode transfer apparatus according to various embodiments of the present disclosure may include a first transfer unit 100, an alignment table 300, a lower adsorption unit 320, a multi-sheet detection unit 700, a second transfer unit 200, and a controller 400.

First, the first transfer unit 100 may hold and transfer the electrode 10′ stacked in the electrode magazine 500. For example, the first transfer unit 100 may hold the electrode 10′ from the electrode magazine 500 by adsorption method and transfer it to the alignment table 300. The first transfer unit 100 may reciprocate between the electrode magazine 500 and the alignment table 300.

Referring to FIG. 2, the first transfer unit 100 may include a first body part 110 configured to cover at least a partial area of the electrode 10′, a first adsorption unit 120 mounted on the first body part 110 and capable of adsorbing the electrode 10′ from above, and a first driver 130 capable of moving and positioning the first body part 110 to transfer the electrode 10′.

The first body part 110 may be provided in the form of a plate having a predetermined area so as to cover at least a partial area of the upper surface of the electrode 10′.

The first body part 110 may be moved and positioned by the first driver 130, which operates under the control of the controller 400. While the first adsorption unit 120 remains activated (i.e., turned on), the first body part 110 may adsorb and move the electrode 10′ to position the electrode 10′.

The first transfer unit 100 may include the first adsorption unit 120 capable of adsorbing and holding the electrode 10′ formed to have a predetermined area. The first adsorption unit 120 may adsorb the electrode 10′ from above. For example, a method of forming a vacuum to generate an adsorption force may be applied to the first adsorption unit 120, a second adsorption unit 220 and a lower adsorption unit 320, but it is not limited thereto, and any method known in the art may be applied as long as it can provide a sufficient fixing force to reposition the electrode 10′ without causing surface damage in the electrode 10′.

In an exemplary embodiment, a plurality of first adsorption units 120 may be arranged with spacing therebetween, enabling the adsorption of upper one surface of the electrode 10′ at multiple positions spaced apart from each other. The first transfer unit 100 may apply an adsorption force to the surface of the electrode 10′ from an upper side of the electrode 10′ using the first adsorption units 120. The first adsorption units 120 may be activated/deactivated (i.e., turned on/off) under the control of the controller 400. The adsorption force of the first adsorption units 120 may be controlled by the controller 400.

The first driver 130 may operate under the control of the controller 400 to reposition the first body part 110. For example, the first driver 130 may move the first body part 110 from the electrode magazine 500 to the alignment table 300 or vice versa. Alternatively, the first driver 130 may move the first body part 110 to a first position other than the alignment table 300.

The first transfer unit 100 may adsorb and transfer an electrode 10′ positioned at the top among the electrodes 10′ stacked in the electrode magazine 500.

The first transfer unit 100 may transfer at least one or more electrodes 10′. In this case, among the electrodes 10′, one electrode 10′ positioned at the top and directly adsorbed by the first transfer unit 100 is normally transferred. However, as described above, two or more electrodes 10′, which are not properly separated from the top electrode 10′, may be unintentionally transferred together.

The first transfer unit 100 may adsorb and transfer the electrode 10′ from above using the first adsorption unit 120. The first transfer unit 100 may transfer the electrode 10′ from the electrode magazine 500 to the alignment table 300.

Alternatively, the first transfer unit 100 may transfer the electrode 10′ (e.g., the upper electrode 10a) on the alignment table 300 to a position other than the alignment table 300, depending on whether the multi-sheet electrode 10 is detected by the multi-sheet detection unit 700. The first transfer unit 100 may also transfer the electrode 10′ from the alignment table 300 to the first position other than the alignment table 300. Here, the first position may refer to any location that does not interfere with the second transfer unit 200 during the process transferring the lower electrode 10b of the multi-sheet electrode 10 by the second transfer unit 200. For example, the first position may be the upper side of the electrode magazine 500, but it is not limited thereto.

The alignment table 300 may be configured to support the electrode 10′ placed thereon. The alignment table 300 may adjust the alignment of the electrode 10′ placed on the table. The alignment table 300 disposed at the distance from the electrode magazine 500.

Referring to FIG. 2, the alignment table 300 may include a table body having a predetermined area designed to accommodate the electrode 10′ placed thereon, the lower adsorption unit 320 disposed on the table body to adsorb the electrode 10′ from below and a table driver 330 configured to control the movement of the table.

The table body part may have an upper portion with predetermined area designed to accommodate the electrode 10′ placed thereon. The table body part may be arranged to face the first body part 110 of the first transfer unit 100. The movement of the table body part may be controlled by the table driver 330, which operates under the control of the controller 400, thereby adjusting the alignment state of the electrode 10′.

The alignment table 300 may be provided with the lower adsorption unit 320 capable of adsorbing and holding the electrode 10′ from below. A plurality of lower adsorption units 320 may be arranged with spacing therebetween, enabling the adsorption of lower one surface of the electrode 10′ placed on the alignment table 300 at multiple positions spaced apart from each other. For example, the lower adsorption units 320 may be arranged in a number corresponding to the first adsorption unit 120. For example, each of the plurality of lower adsorption units 320 may be arranged at positions corresponding to the respective plurality of first adsorption units 120. For example, the plurality of lower adsorption units 320 may be arranged coaxially with the plurality of first adsorption units 120, respectively.

The lower adsorption unit 320 may apply an adsorption force to the lower one surface of the electrode 10′ from a lower side of the electrode 10′. For example, the lower adsorption unit 320 may apply an adsorption force to the electrode 10′ in the direction opposite to that of the first adsorption unit 120 of the first transfer unit 100.

The lower adsorption unit 320 may be activated/deactivated under the control of the controller 400. The adsorption force of the lower adsorption unit 320 may be controlled by the controller 400.

The alignment table 300 may adjust the alignment state of the electrode 10′ placed on the table. The electrode transfer apparatus of the present disclosure may detect the alignment state of the electrode 10′ through the alignment detection unit 800. For example, the alignment detection unit 800 may be a vision sensor, but it is not limited thereto.

If the alignment of the electrode 10′ is misaligned, the table body of the alignment table 300 may adjust the alignment of the electrode 10′ by generating movements such as rotation and/or tilting while the electrode 10′ remains placed thereon. For example, the table body may adjust the alignment while holding the electrode 10′ by the lower adsorption unit 320, thereby preventing distortion of the electrode 10′ during the alignment process.

The multi-sheet detection unit 700 may detect whether the electrode 10′ placed on the alignment table 300 is multi-sheet stacked. Here, multi-sheet stacking of the electrode 10′ may refer to whether the electrode 10′ transferred by the first transfer unit 100 and placed on the alignment table 300 is a single electrode 10′ or the electrode 10′ while two or more electrodes 10′ are stacked.

For example, the multi-sheet detection unit 700 may measure the thickness of the electrode 10′ placed on the alignment table 300 using an ultrasonic sensor to detect whether the electrode 10′ is multi-sheet stacked, but it is not limited thereto.

In an exemplary embodiment, the multi-sheet detection unit 700 may be disposed on one side of the alignment table. For example, the multi-sheet detection unit 700 may be disposed below the electrode 10′ placed on the alignment table to detect whether the electrode 10′ is multi-sheet stacked. However, this is merely illustrative, and the displacement position of the multi-sheet detection unit 700 in the present invention is not limited thereto.

In an exemplary embodiment, the multi-sheet detection unit 700 may be arranged at a position spaced apart from the alignment table. For example, the multi-sheet detection unit 700 may be disposed above the electrode 10′ placed on the alignment table to detect whether the electrode 10′ is multi-sheet stacked. It should be understood that, in the electrode transfer apparatus according to various embodiments of the present invention, the multi-sheet detection unit 700 may be positioned at any location suitable for detecting whether the electrode 10′ is multi-sheet stacked.

In an exemplary embodiment, the controller 400 may compare the thickness of the electrode 10′ detected by the multi-sheet detection unit 700 with a preset reference thickness of the electrode 10′ to determine whether it is the multi-sheet electrode 10. For example, if the thickness of the electrode 10′ detected by the multi-sheet detection unit 700 exceeds the preset reference thickness, the controller 400 may determine that the electrode 10′ is the multi-sheet electrode 10, indicating that two or more thereof are stacked together.

The electrode transfer apparatus according to various embodiments of the present disclosure may include the second transfer unit 200. The second transfer unit 200 may hold and transfer the electrode 10′ placed on the alignment table 300.

The second transfer unit 200 may include a second body part (not shown) configured to cover at least a partial area of the electrode 10′, the second adsorption unit 220 mounted on the second body part and capable of adsorbing the electrode 10′ from above, and a second driver 230 capable of moving and positioning the second body part to transfer the electrode 10′.

The second body part may be provided in the form of a plate having a predetermined area so as to cover at least a partial area of the upper surface of the electrode 10′.

The second body part may be moved and positioned by the second driver 230, which operates under the control of the controller 400. While the second adsorption unit 220 remains activated, the second body part may adsorb and move the electrode 10′ to position the electrode 10′.

The second body part may include the second adsorption unit 220 capable of adsorbing and holding the electrode 10′. For example, the second adsorption unit 220 may adsorb the electrode 10′ from below.

In an exemplary embodiment, the second transfer unit 200 may hold the electrode 10′ placed on the alignment table 300 and transfer it to a second position. For example, the second position may be a designated disposal location for discarding the electrode 10′. For example, if it is determined that the electrode 10′ on the alignment table 300 is the multi-sheet electrode 10, the second transfer unit 200 may hold the separated lower electrode 10b of the multi-sheet electrode 10 and transfer it to the second position.

In an exemplary embodiment, the second transfer unit 200 may transfer the electrode 10′ placed on the alignment table 300 to a stacking table 600. For example, if it is determined that the electrode 10′ is a normal electrode 10′ because the multi-sheet stacking is not detected, the second transfer unit 200 may transfer the electrode 10′ to the stacking table 600, which serves as the next processing. For example, the second transfer unit 200 may transfer the electrode 10′, which has undergone realignment (i.e., alignment adjustment) on the alignment table 300, and place it onto a separation membrane (not shown) placed on the stacking table 600.

The electrode transfer apparatus according to various embodiments of the present disclosure may include the controller 400. The controller 400 may control the movement and positing of the first transfer unit 100, activation/deactivation and adsorption force of the first adsorption unit 120, etc. The controller 400 may control the first transfer unit 100 to transfer the electrode 10′ from the electrode magazine 500 to the alignment table 300.

The controller 400 may determine whether the electrode 10′ placed on the alignment table 300 is the multi-sheet electrode 10 based on the detection results from the multi-sheet detection unit 700. For example, if the thickness of the electrode 10′ detected by the multi-sheet detection unit 700 exceeds the preset reference thickness, the controller 400 may determine that the electrode 10′ currently placed on the alignment table 300 is the multi-sheet electrode 10, indicating that at least two or more electrodes 10′ are stacked. That is, in the present disclosure, the controller 400 may control the first transfer unit 100, the lower adsorption unit 320 of the alignment table 300, and/or the second transfer unit 200 based on the detection results from the multi-sheet detection unit 700.

In an exemplary embodiment, the controller 400 may control the activation/deactivation of the first adsorption unit 120 of the first transfer unit 100 to adjust its adsorption force based on the detection results from the multi-sheet detection unit 700. In addition, the controller 400 may control the magnitude of the adsorption force of the first adsorption unit 120. For example, if it is determined that the electrode 10′ transferred to the alignment table 300 by the first transfer unit 100 is the multi-sheet electrode 10 including the upper electrode 10a and the lower electrode 10b, the controller 400 may maintain the first adsorption unit 120 in an activated state.

For example, if it is determined that the electrode 10′ transferred onto the alignment table 300 is the multi-sheet electrode 10, the controller 400 may activate the first adsorption unit 120 of the first transfer unit 100 to separate the upper electrode 10a from the lower electrode 10b while holding the electrode 10′ (e.g., the upper electrode 10a).

The controller 400 may move the first body part 110 to a position other than the alignment table 300 through the first driver 130. In this case, the first adsorption unit 120 will apply an adsorption force to the electrode 10′ from the upper side of the electrode 10′.

Meanwhile, the controller 400 may activate the lower adsorption unit 320 placed on the alignment table 300 to apply an adsorption force to the electrode 10′ from a lower side of the electrode 10′. In addition, the controller 400 may control the magnitude of the adsorption force of the second adsorption unit.

In the present disclosure, the adsorption force of the first adsorption unit 120 of the first transfer unit 100 and the adsorption force by the lower adsorption unit 320 placed on the alignment table 300 may be applied simultaneously to the electrode 10′, which has been transferred to the alignment table 300 and determined to be the multi-sheet electrode 10. In this case, the adsorption force by the first adsorption unit 120 acts on the upper portion of the electrode 10′, while the adsorption force by the lower adsorption unit 320 acts on the lower portion of the electrode 10′. As a result, the adsorption forces are applied to the electrode 10′ in opposite directions along the stacking direction.

In addition, the controller 400 may control the units in a manner that the magnitude of the adsorption force applied by the first adsorption unit 120 to the upper portion of the multi-sheet electrode 10 is greater than or equal to the magnitude of the adsorption force applied by the lower adsorption unit 320 to the lower portion of the multi-sheet electrode 10.

Therefore, the electrode 10′, which has been determined to be the multi-sheet electrode 10, in the present disclosure may be separated into the lower electrode 10b adsorbed by the lower adsorption unit 320 and the upper electrode 10a adsorbed by the first adsorption unit 120.

The controller 400 may cause the upper electrode 10a, which has been separated as described above, to be transferred to a position other than the alignment table 300 through the first transfer unit 100.

When the multi-sheet electrode 10 is separated into the upper electrode 10a and the lower electrode 10b, the controller 400 may deactivate the lower adsorption unit 320 of the alignment table 300, thereby releasing the adsorption force on the lower electrode 10b.

The controller 400 may activate the second adsorption unit 220 of the second transfer unit 200 to adsorb the lower electrode 10b remaining on the alignment table 300, and then transfer the lower electrode 10b to the designated disposal location.

When it is determined that the electrode 10′ on the alignment table 300 is the normal electrode 10′ rather than the multi-sheet electrode 10 based on the detection results from the multi-sheet detection unit 700, the controller 400 may deactivate the first adsorption unit 120 of the first transfer unit 100.

In addition, the controller 400 may adjust the alignment state of the electrode 10′ placed on the alignment table 300. For example, the controller 400 may control the table driver 330 based on the detection results from the alignment detection unit 800 to adjust the movement of the table body, enabling it to rotate, tilt, and/or reposition. In this case, the controller 400 may control the lower adsorption unit 320 to be activated or deactivated as needed to prevent the electrode 10′ from twisting during the movement of the table body.

The electrode transfer apparatus of the present disclosure may further include the electrode magazine 500 and the stacking table 600.

The electrode magazine 500 may be configured to prepare a plurality of electrodes 10′ in a stacked state. The electrode magazine 500 may be designed to allow the stacked electrodes 10′ to be sequentially transferred from the top by the first transfer unit 100.

For example, the electrode magazine 500 may include an air blower for directing compressed air toward the sides of the stacked electrodes 10′. The air blower may introduce the compressed air between the contact surfaces of each electrode 10′, thereby allowing the respective electrodes 10′ to be separated from each other.

The stacking table 600 may be positioned in the subsequent stage after the alignment table 300. For example, a previously prepared separation membrane may be placed on the stacking table 600. In the present disclosure, the electrode 10′, which has undergone realignment on the alignment table 300, may be transferred by the second transfer unit 200 and placed on the separation membrane of the stacking table 600. Subsequently, an electrode assembly process may be performed.

### Electrode Transfer Process

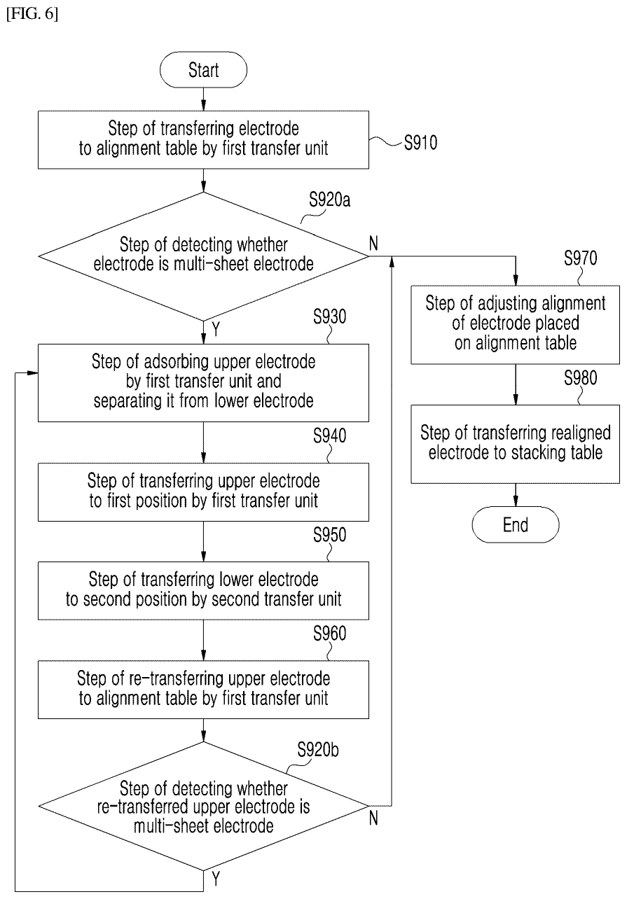

FIG. 5 is a flowchart illustrating the operational sequence of each component of the electrode transfer apparatus according to an exemplary embodiment of the present disclosure.

Hereinafter, an electrode transfer process using the electrode transfer apparatus according to various embodiments of the present disclosure will be described in detail with reference to FIGS. 1 to 5.

First, referring to FIG. 1 (a), a plurality of electrodes 10′ may be stacked and prepared in the electrode magazine 500 before being transferred by the first transfer unit 100.

For ease of understanding, the drawings illustrate the respective electrodes 10′ as being spaced apart from each other. However, in practice, it may be prepared while the electrodes are stacked in direct contact with one another within the electrode magazine 500.

In the present disclosure, to perform the electrode assembly process, the first transfer unit 100 may transfer the electrode 10′ from the electrode magazine 500 to the alignment table 300. The first transfer unit 100 may move to the upper side of the electrode magazine 500, then adsorb and transfer the electrode 10′ positioned at the top on the electrode magazine 500. For example, the first transfer unit 100 may adsorb the electrode 10′ using vacuum adsorption, but it is not limited thereto.

As illustrated in FIG. 5, during the process of transferring the electrode 10′ onto the alignment table 300, the first adsorption unit 120 of the first transfer unit 100 may remain activated.

The electrode 10′ adsorbed by the first transfer unit 100 may be transferred onto the alignment table 300. On the alignment table 300, any misalignment of the electrode 10′ may be corrected before it is transferred to the stacking table 600.

Meanwhile, in an exemplary embodiment, when the first transfer unit 100 adsorbs and transfers the electrode 10′ from the electrode magazine 500, compressed air is blown to the sides of the stacked electrode 10′ through the air blower in the electrode magazine 500, thereby allowing the respective electrodes 10′ to be separated from each other.

However, even if the electrodes 10′ are prepared to be separated in advance using the air blower before transfer, during the actual transfer of the electrodes 10′ by the first transfer unit 100, two or more electrodes 10′ may still be transferred in an overlapped state due to uncontrollable factors such as static electricity.

Here, the electrode 10′, which has been transferred to the alignment table 300 in an overlapped state with two or more electrodes 10′ simultaneously, may be described as the multi-sheet electrode 10 or multi-sheet stacked electrode 10′.

When the electrode 10′ is transferred from the electrode magazine 500 to the alignment table 300 by the first transfer unit 100, the alignment table 300 performs detection and determination to verify whether the transferred electrode 10′ is the multi-sheet electrode 10. Referring to FIG. 5, the multi-sheet detection unit 700 may be activated at this time.

The electrode transfer apparatus of the present disclosure may detect the thickness of the electrode 10′ transferred to the alignment table 300 through the multi-sheet detection unit 700. For example, the multi-sheet detection unit 700 may measure the thickness of the electrode 10′ using an ultrasonic sensor. For example, a receiver and a transmitter of the ultrasonic signal of the multi-sheet detection unit 700 may be positioned on the alignment table 300 and the first transfer unit 100, respectively. When the first transfer unit 100 moves onto the alignment table 300 to place the electrode 10′ on the alignment table 300, the thickness of the placed electrode 10′ may be detected.

In an exemplary embodiment, the result value detected by the multi-sheet detection unit 700 may be transmitted to the controller 400, and the controller 400 may then compare the transmitted detection value with the preset reference thickness value. If the transmitted detection value exceeds the preset reference thickness value, the controller 400 may determine that the electrode 10′ currently transferred to the alignment table 300 is the multi-sheet electrode 10, indicating that two or more electrodes 10′ are stacked together.

In an exemplary embodiment, the process of detecting and determining whether the electrode 10′ transferred from the electrode magazine 500 to the alignment table 300 is the multi-sheet electrode 10 may be described as the primary multi-sheet detection process.

However, although the determination process for the multi-sheet electrode 10 is described here as being performed by the separate controller 400, it is not limited thereto, and the detection and determination process may be performed directly by the multi-sheet detection unit 700.

For example, the first adsorption unit 120 may be continuously activated during the process of placing the electrode 10′ on the alignment table 300 and detecting the thickness to determine whether it is the multi-sheet electrode 10. However, this is merely illustrative, and when the first transfer unit 100 transfers the electrode 10′ and places it on the alignment table 300, the first adsorption unit 120 may be deactivated during the process of detecting the thickness and determining whether it is the multi-sheet electrode 10.

In the present disclosure, the activation/deactivation of the first adsorption unit 120 of the first transfer unit 100 may be controlled to adjust its adsorption force based on the detection results from the multi-sheet detection unit 700.

Referring to FIG. 5, when the electrode 10′ transferred to the alignment table 300 is determined to be the multi-sheet electrode 10, the first adsorption unit 120 of the first transfer unit 100 may be activated.

If the multi-sheet detection unit 700 determines that the electrode is a multi-sheet electrode, the first transfer unit 100 may adsorb the upper electrode 10a among the multi-sheet electrodes 10 from above, and separate the upper electrode 10a from the lower electrode 10b.

In this case, if the electrode 10′ transferred to the alignment table 300 is determined to be the multi-sheet electrode 10, the lower adsorption unit 320 mounted on the alignment table 300 may be activated. Accordingly, the lower adsorption unit 320 may adsorb the lower electrode 10b among the multi-sheet electrodes 10 from below, thereby holding the lower electrode 10b so as to be fixed to the alignment table 300.

In an exemplary embodiment, if the multi-sheet detection unit 700 determines that the electrode is a multi-sheet electrode, adsorption forces in opposite directions are applied to the upper electrode 10a and the lower electrode 10b, thereby allowing the upper electrode 10a to be separated from the lower electrode 10b. For example, the adsorption force by the first adsorption unit 120 of the first transfer unit 100 may be formed to be greater than or equal to the adsorption force of the lower adsorption unit 320. If the adsorption force of the first adsorption unit 120 is formed to be smaller than the adsorption force of the lower adsorption unit 320, smooth separation of the upper electrode 10a may be difficult.

The first transfer unit 100 may transfer the electrode 10′ to the first position other than the alignment table 300 while holding the upper electrode 10a. As the upper electrode 10a is transferred by the first transfer unit 100, the upper electrode 10a and the lower electrode 10b may be separated from each other.

Meanwhile, referring to FIG. 3, the upper electrode 10a and the lower electrode 10b forming the multi-sheet electrode 10 generally have a rectangular shape and are stacked to correspond to each other. However, when the electrode 10′ is transferred to the alignment table 300 by the first transfer unit 100, the lower electrode 10b, which was not directly adsorbed by the first adsorption unit 120, tends to have a relatively higher defect rate, and may differ in shape or size from the upper electrode 10a, which was adsorbed by the first adsorption unit 120.

In the present disclosure, a plurality of lower adsorption units 320 of the alignment table 300 may be arranged at multiple positions so as to adsorb at least a partial region of the lower electrode 10b. Further, in the electrode transfer apparatus of the present disclosure, each of the plurality of lower adsorption units 320 are arranged coaxially with the first adsorption units 120 of the plurality of first transfer units 100, respectively. As a result, even if the lower electrode 10b has any shape or size different from that of the upper electrode 10a, the multi-sheet electrode 10 can still be effectively separated into the upper and lower electrodes 10a and 10b.

Referring again to FIG. 1 (b), in an exemplary embodiment of the present disclosure, when the upper electrode 10a and the lower electrode 10b forming the multi-sheet electrode 10 are separated from each other, the first transfer unit 100 may transfer the adsorbed upper electrode 10a to a position other than the alignment table 300. In this case, the first adsorption unit 120 may remain activated.

For example, the first transfer unit 100 may return the separated upper electrode 10a to the upper portion of the electrode magazine 500, but it is not limited thereto, and the electrode 10′ may be transferred to any position necessary for the process as long as it does not interfere with the second transfer unit 200.

After the upper electrode 10a is separated from the lower electrode 10b and transferred, the lower electrode 10b remains on the alignment table 300. Once the lower electrode 10b is separated, the lower adsorption unit 320 placed on the alignment table 300 may be deactivated, thereby releasing the adsorption force applied to the lower electrode 10b.

The second transfer unit 200 may move onto the alignment table 300 to adsorb the lower electrode 10b remaining on the alignment table 300. In this case, since the lower adsorption unit 320 is in a deactivated state, the lower electrode 10b may be adsorbed by the second adsorption unit 220 of the second transfer unit 200.

Referring to FIG. 1 (c), the second transfer unit 200 may transfer the lower electrode 10b remaining on the alignment table 300 to the second position. The second position may be a position different from the first position of the first transfer unit 100. For example, the second position may be the designated disposal location for discarding the electrode 10′. However, this is merely illustrative, and the second position may also be a location for collecting the lower electrode 10b among the multi-sheet electrodes 10, where its quality is assessed to determine whether it is acceptable for further use. During this process, the second adsorption unit 220 may remain activated.

When the lower electrode 10b is removed from the alignment table 300, the first transfer unit 100, which has been moved to the location other than the alignment table 300 while holding the upper electrode 10a, may re-transfer the upper electrode 10a back to the alignment table 300. During re-transfer, the first adsorption unit 120 may remain activated.

When the upper electrode 10a is re-placed on the alignment table 300 by the first transfer unit 100, the above-described multi-sheet detection process may be performed again.

In an exemplary embodiment, the multi-sheet detection process performed on the re-transferred upper electrode 10a may be described as a secondary multi-sheet detection process. For example, the secondary multi-sheet detection process may be a multi-sheet detection process performed on the upper electrode 10a, which has been determined to be the multi-sheet electrode 10 through the primary multi-sheet detection process and separated. For example, the method of detecting the multi-sheet electrode 10 may be the same as the primary multi-sheet detection process, except that the secondary multi-sheet detection process targets the upper electrode 10a, which was separated through the primary multi-sheet detection process. In the present disclosure, since the secondary multi-sheet detection process is performed after the primary multi-sheet detection process, the multi-sheet defect of the electrode 10′ can be minimized, even in the picked up multi-sheet electrode 10 in which three or more sheets are stacked.

For example, in the electrode transfer apparatus of the present disclosure, the thickness of the upper electrode 10a may be detected by the multi-sheet detection unit 700, and the upper electrode 10a may be determined to be the multi-sheet electrode 10 in which two or more electrodes 10′ are still stacked.

For example, in the electrode transfer apparatus of the present disclosure, if the upper electrode 10a is still determined to be the multi-sheet electrode 10, the lower adsorption unit 320 mounted on the alignment table 300 and the first adsorption unit 120 of the first transfer unit 100 may both be activated to separate the lower electrode 10b from the upper electrode 10a once again. Here, the lower electrode 10b refers to the electrode 10′ arranged at the bottommost among the multi-sheet electrodes 10′ forming the plurality of electrodes 10, while the upper electrode 10a refers to the remaining electrode 10′ excluding the lower electrode 10b, as described above.

In the present disclosure, since the electrode 10′ transfer and multi-sheet detection process by the first transfer unit 100 is repeatedly performed, even in the case of the multi-sheet electrode 10 in which three or more electrodes 10′ are stacked, the problem of incorporating two or more electrodes 10′ into the electrode assembly may be minimized.

That is, the electrode transfer apparatus of the present disclosure can minimize the waste rate and maximize the electrode 10′ yield for the remaining electrodes 10′ excluding the lower electrode 10b arranged at the bottommost, regardless of the number of stacked electrodes 10′ in the multi-sheet electrode 10.

Meanwhile, referring to FIG. 1 (d), based on the detection results from the multi-sheet detection unit 700, it is determined that the electrode 10′ (or the re-transferred upper electrode 10a) transferred to the alignment table 300 by the first transfer unit 100 is not the multi-sheet electrode 10, the adsorption force of the first transfer unit 100 for the electrode 10′ may be released. In this case, the first adsorption unit 120 may be deactivated, and the lower adsorption unit 320 may be activated.

When the adsorption by the first transfer unit 100 is released, the electrode 10′ may be placed on the alignment table 300. The electrode 10′ placed on the alignment table 300 may be realigned through movement such as rotation and/or positional adjustment of the alignment table 300. For example, to prevent distortion of the electrode 10′ during the alignment process, the realignment of the electrode 10′ may be performed while the lower adsorption unit 320 remains activated and the electrode 10′ is adsorbed by the lower adsorption unit 320.

In an exemplary embodiment of the present disclosure, the alignment state of the electrode 10′ may be detected by an alignment detection sensor. Then, the detected result may be compared with a preset reference alignment state by the controller 400, and the electrode 10′ alignment process may be repeatedly performed until it matches the preset alignment state of the electrode 10′.

After the realignment process on the alignment table 300 is completed, the adsorption force applied to the electrode 10′ by the lower adsorption unit 320 of the alignment table 300 may be released, while the second adsorption unit 220 of the second transfer unit 200 may be activated to apply an adsorption force to the electrode 10′. The electrode 10′ adsorbed by the second transfer unit 200 may be transferred to the stacking table 600. In this case, the second adsorption unit 220 may remain activated. For example, the electrode 10′ transferred to the stacking table 600 by the second transfer unit 200 may be placed on a separation membrane that is pre-positioned on the stacking table 600. After placement, the electrode assembly process may be performed.

Referring to FIG. 1 (e), when the electrode 10′, which has undergone realignment on the alignment table 300, is transferred by the second transfer unit 200, the first transfer unit 100 may transfer the electrode 10′ from the electrode magazine 500 to the alignment table 300. In addition, the electrode 10′ transferred to the alignment table 300 is determined to be the normal electrode 10′, the electrode 10′ may undergo a realignment process, and then be transferred to the stacking table 600 by the second transfer unit 200.

### Electrode 10′ Transfer Method

FIG. 6 is a flowchart illustrating procedures of a method for transferring the electrode 10′ according to an exemplary embodiment of the present disclosure.

Referring to the electrode transfer process described above and the illustration in FIG. 6, the electrode 10′ transfer method of the present disclosure may include a step (S910) of transferring the electrode 10′ to the alignment table 300 by the first transfer unit 100. For example, the electrode 10′ may be transferred while two or more sheets are stacked.

Then, the present disclosure may include a step (S920a) of detecting whether the electrode 10′ is a multi-sheet electrode 10 in which the upper electrode 10a and the lower electrode 10b are stacked. For example, in the present disclosure, the multi-sheet detection step for the electrode 10′ picked up from the electrode magazine 500 may be described as a primary multi-sheet detection step (S920a).

According to the electrode 10′ transfer method of the present disclosure, if the multi-sheet electrode 10 is detected, a step (S930) of adsorbing the upper electrode 10a by the first transfer unit 100 and separating it from the lower electrode 10b may be performed.

The step (S930) of separating the upper electrode 10a and the lower electrode 10b may be performed while the lower electrode 10b is adsorbed by the lower adsorption unit 320 and remains on the alignment table 300. Further, in this step, the upper electrode 10a and the lower electrode 10b forming the multi-sheet electrode 10 may be separated from each other by applying opposite adsorption forces to the multi-sheet electrode 10, in a way that the first adsorption unit 120 applies force from above and the lower adsorption unit 320 applies force from below.

The electrode 10′ transfer method may include a step (S940) of transferring the upper electrode 10a, which is adsorbed by the first transfer unit 100, to a first position other than the alignment table 300. Here, the first position may be the upper side of the electrode magazine 500, but it is not limited thereto.

The electrode 10′ transfer method may further include a step (S950) of transferring the lower electrode 10b remaining on the alignment table 300 to a second position by the second transfer unit 200. This step may be performed while the lower adsorption unit 320 is deactivated. In an exemplary embodiment, in the step (S950) of transferring the lower electrode 10b to the second position, the second transfer unit 200 may transfer the lower electrode 10b to the designated location for discarding.

The electrode 10′ transfer method may include a step (S960) of re-transferring the upper electrode 10a, which was transferred to the first position by the first transfer unit 100, to the alignment table 300.

In addition, the electrode 10′ transfer method of the present disclosure may further include a step (S920b) of detecting whether the re-transferred upper electrode 10a is the multi-sheet electrode 10. For example, the multi-sheet detection step for the re-transferred upper electrode 10a in the present disclosure may be described as a secondary multi-sheet detection step (S920b).

Meanwhile, the electrode 10′ transfer method according to an exemplary embodiment of the present disclosure may include a step (S970) of adjusting the alignment state of the electrode 10′ when the electrode 10′ placed on the alignment table 300 is not the multi-sheet electrode 10. This step may be performed by driving the alignment table 300 based on the detection results from the alignment detection unit 800 as described above.

When the alignment of the electrode 10′ on the alignment table 300 is completed, the electrode 10′ transfer method of the present disclosure may further include a step (S980) of transferring the realigned electrode 10′ to the stacking table 600. In this case, a separation membrane may be pre-positioned on the stacking table 600, and the realigned electrode 10′ may be placed on the separation membrane.

The cathode and anode may be transferred to be alternately arranged on the separation membrane using the electrode transfer apparatus of the present disclosure. In this case, the separation membrane may be folded to ensure that the alternately stacked cathodes and anodes do not come into direct contact with each other.

The electrode transfer apparatus and method according to various embodiments of the present disclosure described above may minimize the waste rate of electrode 10′ caused by the pick-up of the multi-sheet electrode 10 from the electrode magazine 500 by distinguishing between the upper electrode 10a and the lower electrode 10b among the multi-sheet electrode 10, and discarding only the lower electrode 10b while allowing the upper electrode 10a to be used as the normal electrode 10′.

In the present disclosure, since the electrode 10′ transfer and multi-sheet detection process by the first transfer unit 100 is repeatedly performed, even in the case of the multi-sheet electrode 10 in which three or more electrodes 10′ are stacked, the risk of incorporating two or more electrodes 10′ into the electrode assembly may be minimized.

The electrode transfer apparatus of the present disclosure can minimize the waste rate and maximize the electrode 10′ yield for the remaining electrodes 10′ excluding the lower electrode 10b arranged at the bottommost, regardless of the number of stacked electrodes 10′ in the multi-sheet electrode 10.

In the above, although the embodiments of the present disclosure have been described with all components combined in one or operating in combination, the present disclosure is not limited to these embodiments. Within the scope of the purpose of the present disclosure, all components may be selectively combined in one or more and operated accordingly. Unless otherwise defined, all terms including technical or scientific terms have the same meaning as generally understood by those skilled art in the art to which the present disclosure pertains. Commonly used terms, such as terms defined in a dictionary, should be interpreted in accordance with the contextual meaning of the related art, and shall not be interpreted in an idealized or excessively formal meaning, unless explicitly defined in the present disclosure.

The description is merely illustrative of the technical idea of the present disclosure, and those skilled art in the art to which the present disclosure pertains will appreciate that various modifications and variations are possible without departing from the essential characteristics of the present disclosure. Therefore, the embodiments disclosed in the present disclosure are intended to describe the technical idea of the present disclosure, and are not intended to limit the same, as well as the scope of the technical idea of the present disclosure is not limited to these embodiments. It should be understood that the protective scope of the present disclosure is interpreted by the claims below, and all technical ideas within the equivalent range are included in the scope of the present disclosure.

What is claimed is:

1. An electrode transfer apparatus comprising:
an electrode magazine configured to load electrodes;
an alignment table disposed at a distance from the electrode magazine;
a first transfer unit configured to reciprocate between the electrode magazine and the alignment table, and adsorb and transfer the electrode;
a multi-sheet detection unit configured to detect whether an electrode placed on the alignment table is a multi-sheet electrode;
a lower adsorption unit mounted on the alignment table and configured to adsorb the electrode from below; and
a controller configured to control activation/deactivation (on/off) of the adsorption force of the first transfer unit based on detection results from the multi-sheet detection unit.

2. The electrode transfer apparatus according to claim 1, wherein the controller controls the first transfer unit to adsorb the multi-sheet electrode from above and separate at least a portion of the multi-sheet electrode.

3. The electrode transfer apparatus according to claim 2, wherein the controller controls the first transfer unit to transfer the separated portion of the multi-sheet electrode to a first position other than the alignment table.

4. The electrode transfer apparatus according to claim 1, wherein the adsorption force applied by the first transfer unit and the adsorption force applied by the lower adsorption unit act on the electrode in opposite directions.

5. The electrode transfer apparatus according to claim 1, wherein the adsorption force applied by the first transfer unit is configured to be greater than or equal to the adsorption force applied by the lower adsorption unit.

6. The electrode transfer apparatus according to claim 1, wherein the multi-sheet detection unit detects a thickness of the electrode placed on the alignment table to determine whether it is a multi-sheet electrode.

7. The electrode transfer apparatus according to claim 2, wherein the controller controls the lower adsorption unit to be deactivated when the portion of the multi-sheet electrode is separated by the first transfer unit.

8. The electrode transfer apparatus according to claim 2, further comprising a second transfer unit configured to transfer the residual portion of the multi-sheet electrode remaining on the alignment table to a second position.

9. The electrode transfer apparatus according to claim 1, wherein the first transfer unit comprises a plurality of first adsorption units arranged at multiple positions to adsorb the electrode from above, and a plurality of lower adsorption units are arranged at multiple positions,
wherein the first adsorption units are arranged at positions corresponding to the lower adsorption units, respectively.

10. An electrode transfer method comprising:
adsorbing an electrode and transferring it to an alignment table, by a first transfer unit;
detecting whether the electrode is a multi-sheet electrode in which an upper electrode and a lower electrode are stacked, by a multi-sheet detection unit; and
controlling activation/deactivation (on/off) of the adsorption force of the first transfer unit based on detection results from the multi-sheet detection unit, by a controller.

11. The electrode transfer method according to claim 10, further comprising, when the adsorption force of the first transfer unit is activated, adsorbing the upper electrode and separating it from the lower electrode, by the first transfer unit,
wherein the step of adsorbing the upper electrode and separating it from the lower electrode is performed while the lower electrode is adsorbed by the lower adsorption unit and remains on the alignment table.

12. The electrode transfer method of claim 11, wherein the adsorption force applied to the upper electrode by the first transfer unit and the adsorption force applied to the lower electrode by the lower adsorption unit act on the electrode in opposite directions.

13. The electrode transfer method of claim 11, wherein the adsorption force applied to the upper electrode by the first transfer unit is configured to be greater than or equal to the adsorption force applied to the lower electrode by the lower adsorption unit.

14. The electrode transfer method of claim 10, further comprising transferring the upper electrode adsorbed by the first transfer unit to a first position other than the alignment table.

15. The electrode transfer method of claim 11, further comprising transferring the lower electrode remaining on the alignment table to a second position by the second transfer unit.

16. The electrode transfer method according to claim 15, wherein the step of transferring the lower electrode to the second position is performed while the lower adsorption unit is deactivated.

17. The electrode transfer method according to claim 15, further comprising, when the lower electrode is transferred to the second position, re-transferring the upper electrode to the alignment table, by the first transfer unit.

18. The electrode transfer method according to claim 17, further comprising detecting whether the re-transferred upper electrode is a multi-sheet electrode.

19. The electrode transfer method according to claim 18, further comprising, when the multi-sheet electrode is not detected, adjusting the alignment state of the electrode placed on the alignment table.

20. The electrode transfer method according to claim 19, further comprising transferring the electrode or the upper electrode, which has undergone alignment adjustment, to a stacking table, by the second transfer unit.
